(19) United States
(12) Patent Application Publication
(10) Pub. No.: US 2006/0071576 A1
(43) Pub. Date: Apr. 6, 2006

(54) Flat board type brushless dc motor

(76) Inventor: Yun-Hyun Cho, Busan (KR)

Correspondence Address: GWIPS;PETER T. KWON, 1600-3 SEOCHO-DONG, SEOCHO-GU,, DAELIM BUILDING, 9TH FLOOR, SEOUL, 137-877, KR

(21) Appl. No.: 10/529,135

(22) PCT Filed: Sep. 26, 2003
(86) PCT No.: PCT/KR03/01968

§ 371 Date: Mar. 23, 2005

(30) Foreign Application Priority Data
Sep. 27, 2002 (KR) 10-2002-0059987
Sep. 24, 2003 (KR) 10-2003-0066385

(51) Int. Cl. H02K 1/00; H02K 1/22

(52) U.S. Cl. 310/268; 310/216

(57) ABSTRACT

A flat board type brushless DC motor is invented comprising a stator core having a laminated flat core structure of a ring type which is slotted a constant distance slot for installing the teeth core and winding the exciting coil on the inner or outer circumference of a stator core circle. The teeth core has a constant thickness with a certain number of teeth. The rotor faced against the stator is consisted of the rotor shaft, the circular flat rotor frame fixed on the motor shaft and assembled with even number of the N- and S-permanent magnets on the circle flat rotor of the flat type brushless and synchronous motor.

### BACKGROUND OF THE INVENTION

1. Field of the Invention

The present invention relates to a flat board type brushless DC (BLDC) motor which has more than one plate stator and rotor structure. More particularly, the stator structure consists of the slotted lamination stator core and laminated stator teeth core. The rotor structure consists of a magnetic plate core installed with a permanent magnet or a laminated rotor core with a die-casting aluminum or copper of the short circuit configuration. The stator and rotor are faced each other. The BLDC motor is basically configured a housing frame with stator, shaft, rotating frame with rotor and bearings. The multi flat board type BLDC motor forms more than one structure of the stators and rotors. The flat board type BLDC motor of the present invention is able to increase the output power by using wider diameter against axial length per unit volume. So, it is possible to vary the capacity of output power by adopting the multiple stators and rotors to produce the higher power.

2. Related Prior Art

A conventional motor is made of the stator and rotor of a cylindrical type. FIG. 1 shows the conventional stator configure with the slotted core, which is axially laminated, for the winding coil. Also the conventional rotor has the configuration of a cylindrical type in the inner of the stator core like FIG. 2.

As shown FIG. 2a, the permanent magnet rotor is installed as an array permanent laminated, for the winding coil. Also the conventional rotor has the configure of a cylindrical type in the inner of the stator core like FIG. 2.

As shown FIG. 2(a), the permanent magnet rotor is installed as an array permanent magnet for making the magnetic pole on the rotor surface. FIG. 2b shows the rotor of the conventional induction motor which is made of the aluminum die-casting or copper. The conventional motor, which is consisted of the above stator (FIG. 2a) and rotor (FIG 2b), is the FIGS. 3a and 3b. The effective section area (S_{eff) of a conventional motor is calculated as the product, S}_{eff}=μD_{eff}L_{eff}, of the inner diameter (D_{eff}) and the laminated core axial length (L_{eff}) of stator.

To increase the power capacity of motor, the laminated axial core length (L_{eff}) of stator and rotor must be changed and extended. Otherwise the diameter (D_{eff}) of motor must be extended. These case methods are cause of the weight and volume of motor and it will be higher the product cost of motor according to the material cost.

### SUMMARY OF THE INVENTION

The object of invention is to provide the flat type motor with more larger the diameter than the axial length of motor to product the high torque density per unit volume and the flat type motor with the structure of flat type to easily fit and increase the number of the stator and rotor due to the demand of the output power capacity. Because of the invention case of the motor with the multi stator and rotor, we are called as the multi flat type motor. This flat type motor is consisted of the flat stator, the flat rotor, the shaft and the housing frame.

The structure configuration of the stator (FIG. 6) is consisted of the laminated magnetic teeth core (FIG. 4b ) with the multiple teeth core for winding coil, the laminated magnet stator (FIG. 4a ) with the multiple slots for the install of the laminated teeth core and the back iron plate frame as shown FIG. 5.

The flat type rotor is installed on the shaft for the rotating against of the flat type stator.

the structure configuration of the flat rotor is consisted of the permanent magnet and the back iron flat for a permanent magnet motor such as a brushless DC motor and a synchronous permanent magnet motor. On the other one, for a flat type induction motor, the structure configuration of the flat rotor has the same structure such as the flat stator of FIG. 5. But the flat rotor has the aluminum die-casting or the copper short circuit as shown FIG. 9a and FIG. 9b in the stead of the winding coil of stator.

### BRIEF DESCRIPTION OF THE DRAWINGS

FIG. 1 is the drawing of the conventional cylindrical stator core.

FIG. 2a and FIG. 2b are the drawings of the conventional cylindrical rotor core.

FIG. 3a and FIG. 3b are the drawings of the conventional cylindrical motor structure made of the magnetic stator core and rotor core of FIG. 1 and FIG. 2.

FIG. 4a is this invention drawing which is described the magnetic stator core having the inner and the outer slotted core configuration for the inserting and the fitting of the laminated teeth core.

FIG. 4b is this invention drawing which is described the teeth core of a flat type motor.

FIG. 5 is this invention drawing which is described the stator core of a flat type motor.

FIG. 6 is this invention drawing which is described the stator assembled the stator and the teeth core together.

FIG. 7a is this invention drawing shown at the front view for the permanent magnet rotor of a flat type motor and FIG. 7b is this invention drawing of the rotor assembled the permanent magnet and the back iron flat.

FIG. 8a, 8b and 8c are these invention drawings of the single module, the dual module and multi module flat type motor for the permanent magnet brushless and synchronous motor.

FIG. 9a is this invention drawing which is described the rotor of a flat type motor against the rotor of the conventional induction motor.

FIG. 9b is this invention drawing of the rotor structure assembled on the rotating shaft for a flat type motor against a induction motor.

FIG. 9c is this invention drawing of a flat type induction motor assembled a flat stator and a flat rotor on the shaft together.

FIG. 10a is this invention drawing of the dual flat type induction motor with the two stator and two motor.

FIG. 10b is the invention drawing of the multi flat type induction motor.

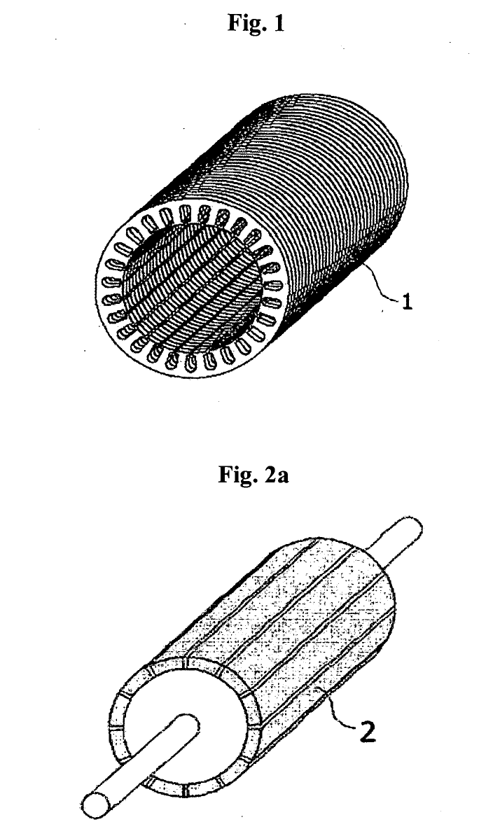

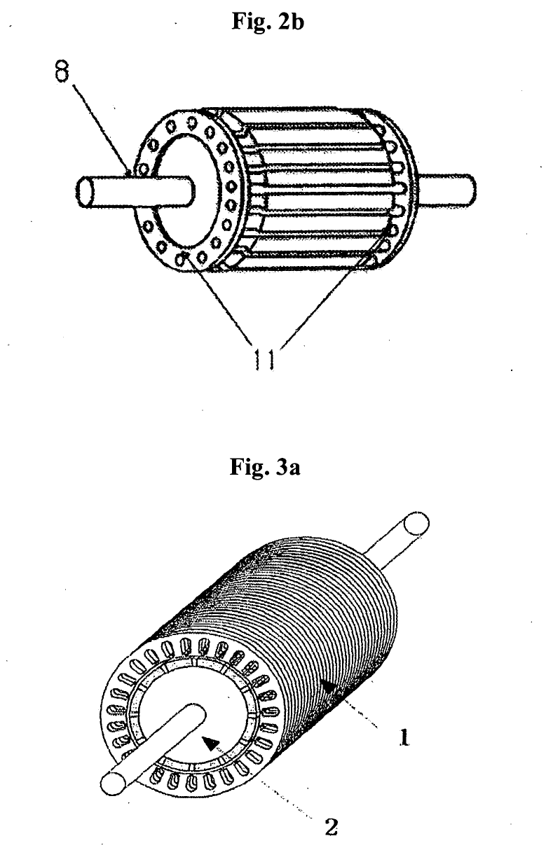

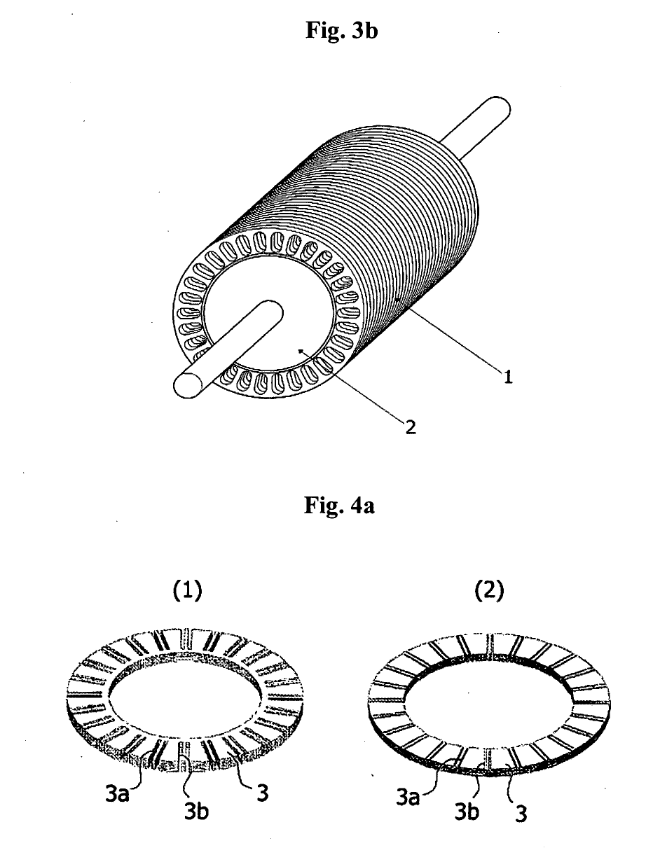

### BEST MODE FOR CARRYING OUT THE INVENTION

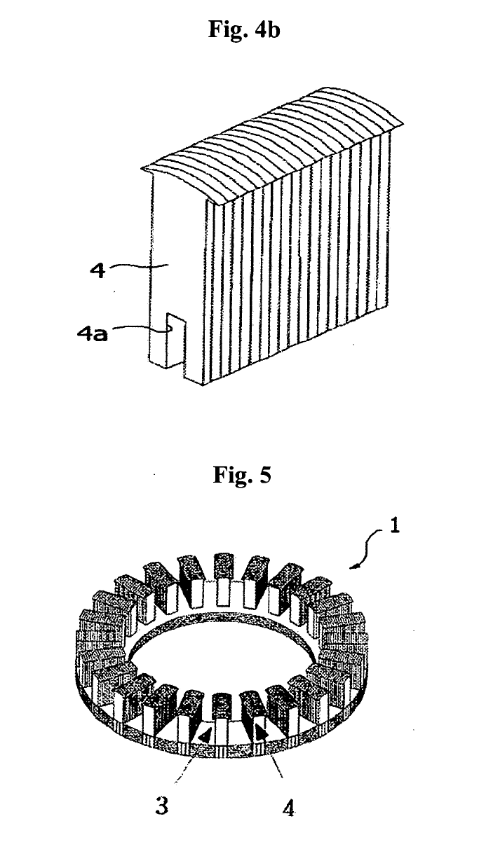

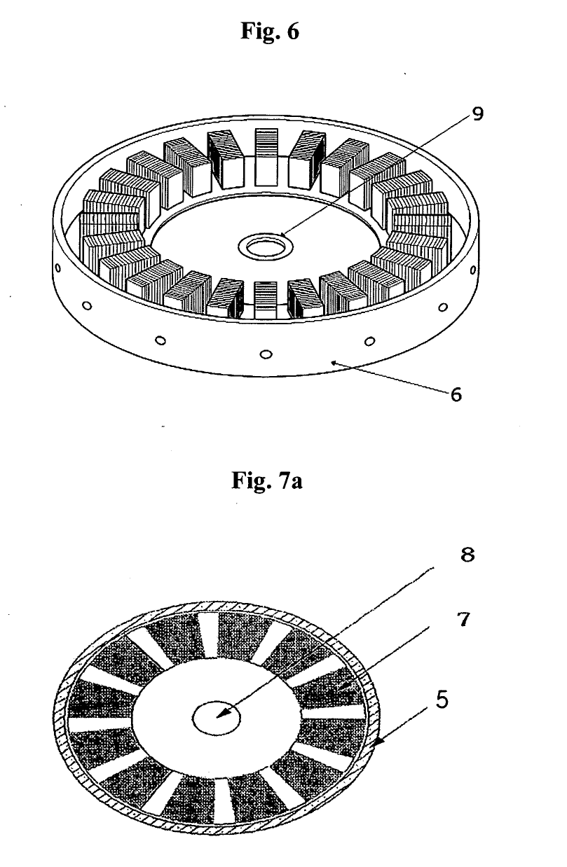

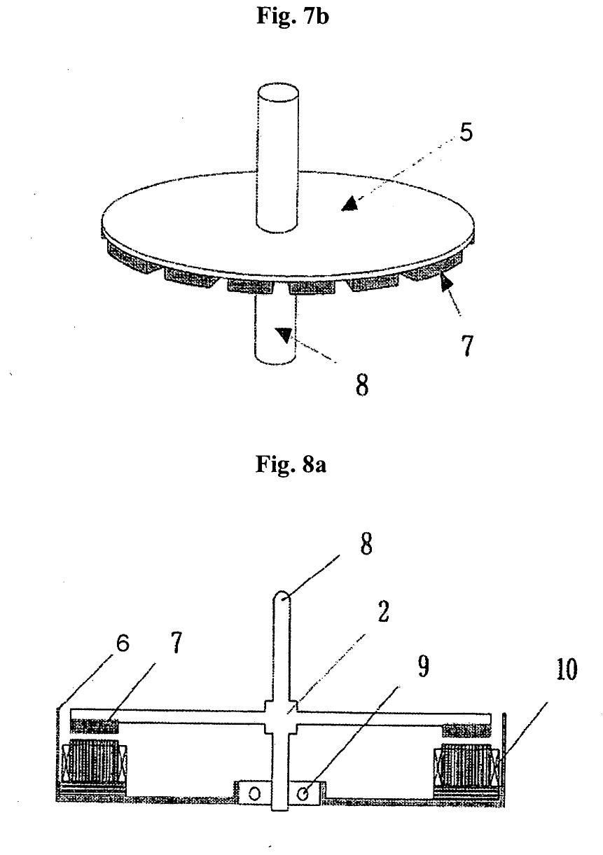

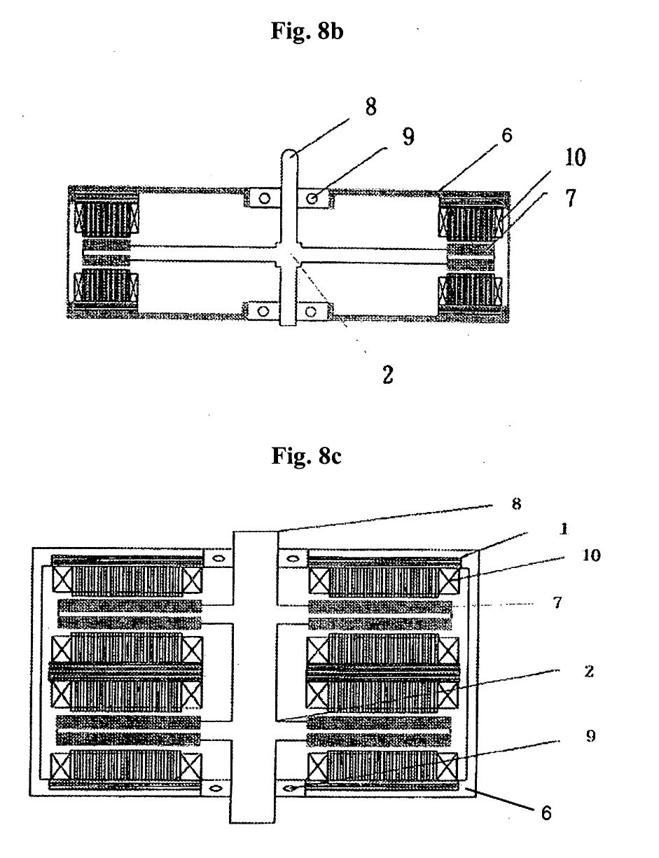

Due to the drawing, this invention can be carried out as followings. The flat type motor of this invention has the structure assembled the flat stator (1), the flat rotor (2) and the housing (6) shown FIG. 4 through FIG. 8. The above housing (6) is made to support the shaft axis of rotor which is installed to rotate the rotor (2) against the stator (1) assembled the multi laminated stator core (FIG. 4a) and the teeth core (FIG. 4b). The above stator (1) is installed in the side of the housing (6) and made of the laminated stator core (3) and the laminated teeth core (4).

The stator core (3) has the laminated flat core structure of a ring type which is slotted a constant distance slot for the install of the teeth core (4) and the winding of the exciting coil (10) on the circumference of a stator core circle.

The stator slot (3b) of the above stator core (3) has the structure configure which is made of the multi slot with a constant distance on the inner or outer circumference of a stat core circle in order to install the teeth core (4).

The above teeth core (4) has a constant thickness which is consisted of a number of teeth core. Similarly, the above stator core (3) has a constant thickness which is consist of a number of stator core.

The rotor (2) against the above stator (1) is consisted of the rotor shaft (8) and the circle flat rotor frame (5) fixed on the motor shaft and is assembled the permanent magnet (7) of the N and S-pole on the circle flat rotor for the regular magnetic pole. The above rotor shaft (8) is connected to the bearing fixed at the motor housing frame (6). The permanent magnet (7) has the even magnetic pole array of N and S pole according to the magnetic pole number of motor.

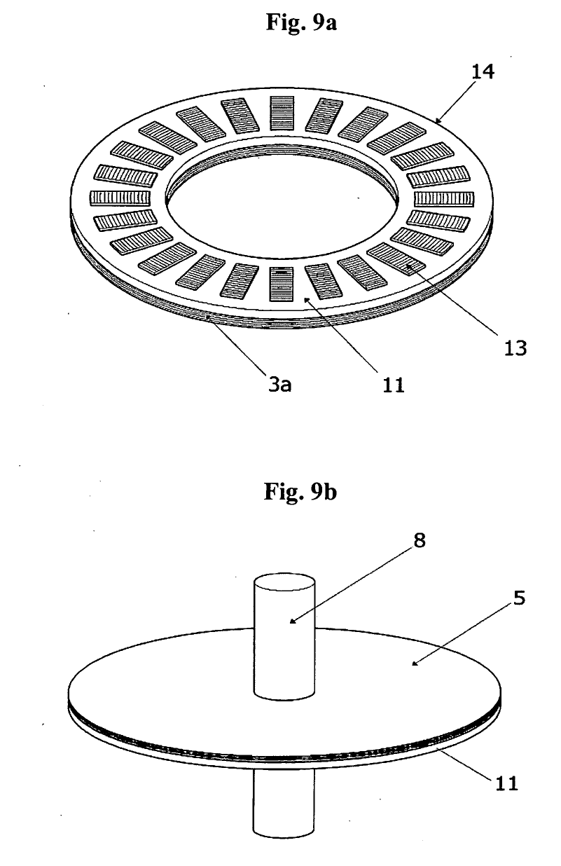

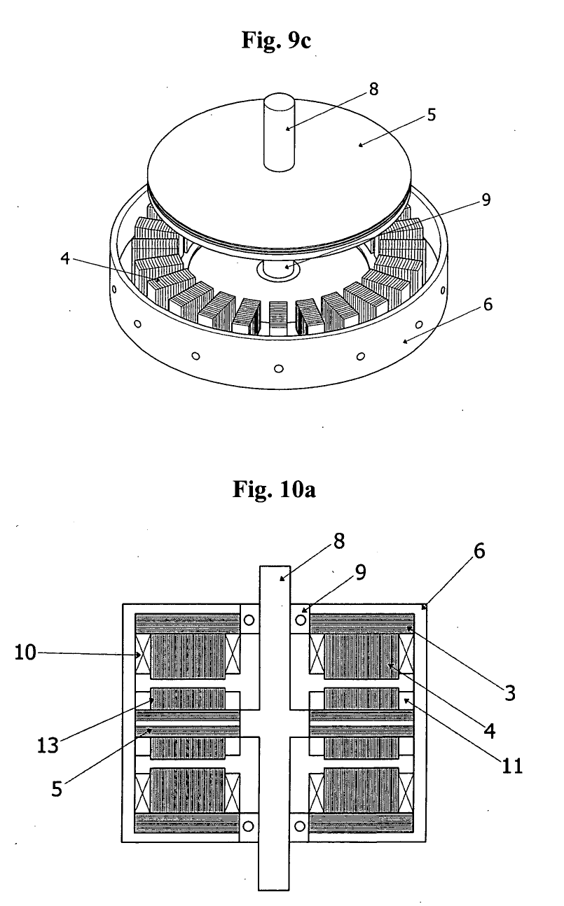

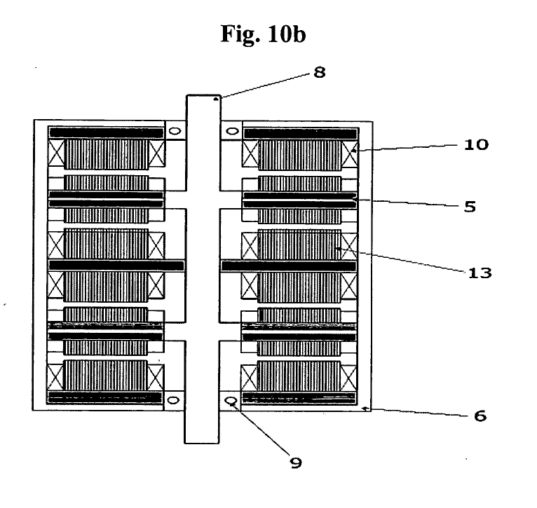

As shown FIG. 8a, 8b and 8c, in order to increase the torque of motor, the number of stator frame (5) which is consisted of the stator core (3) and the teeth core (4) and the number of the rotor frame (5) which is made of the permanent magnet for a permanent magnet brushless motor and synchronous motor or the short circuit flat type (FIG. 9a) for the flat type induction motor must be added.

As shown FIG. 9a and FIG. 9b, the rotor of this invention is consisted of the rotor core and teeth core such as the stator core(3) and the teeth core (4) for the flat type induction motor against the conventional induction motor. To flow the induced current on the flat type rotor, the rotor (14) has the short circuit conductor (11) with the aluminum die-casting conductor or the copper.

As above the expressions, the flat type motor of this invention has the structure which the diameter of motor is larger than the axial length of motor. And the flat type motor has the laminated magnetic stator core as the drawing of 4a and 4b and the laminated teeth core as the drawing of 5 for the magnetic circuit path from the exciting winding current and the flat type permanent magnet rotor.

Also, The winding of the above teeth core, as shown the drawing of 5, is located and fixed at the span of the teeth core and the teeth core. The stator core (3) coupled with the teeth core (4) is fixed at the housing frame as shown the drawing of 6.

In this invention, the effective area (A_{eff}) for the production of motor torque is calculated by the difference of the area of outer diameter (π D²_{OUT}/4) and the area of inner diameter (π D²ᵢₙ/4) about the circle flat stator. If the diameter of motor is a constant, the capacity increment of the flat type motor can be used and satisfied as the addition of a unit flat type motor as shown the drawing of 8a on the same rotating shaft. It is possible to design and manufacture the flat type motor on the same rotating axis for the double and the multi flat type motor which is made of the unit flat type motor. So that, it is easy to manufacture the flat type motor and it is possible to make the structure which the flat type motor can be produced the high torque per unit volume. The shape of the permanent magnet and the teeth core is designed to minimize the cogging torque and the torque ripple.

The specification according to the voltage and the pole number of the flat type motor is designed and manufactured on the base of the unit flat type motor. The number of slot (Z₁) for the flat type motor is decided from the below equation as functions of the phase number (m), pole number(P) and the slot number per phase per pole(q).
Z₁=mPq (math. equation)

Also, the winding coil (10) of the flat type motor is decided by the pole number and the winding method and the teeth number of the rotor is selected to minimize the vibration and the noise as the combination of the teeth number of the stator and the magnetic pole number of the rotor.

This invention is proposed that the motor has the structure with more the larger diameter than the axial length of the motoe when the conventional motor is compared. So that, it can be easily manufacture the thin flat type motoe of the short length axis and the large diameter. Also, to increase the demand power capacity, if the unit flat stator and rotor is added and assembled on the shaft, it is possible to make the unit flat type, the double flat type and the multi flat type motor with more the high efficiency and the torque per unit volume than the conventional motor.

The torque of the flat type motor depends on the difference area of the outer diameter section area and the inner diameter section area but the torque of a conventional motor depends on the product, S_{eff}=μD_{eff}L_{eff}, of the inner diameter(D_{eff}) and the laminated core axial length (L_{eff) of stator. So that, the flat type motor can produce the high torque with more the small volume and the light weight per the input power than the conventional motor and make the thin axial motor with more the larger diameter than the axial direction thickness.}

This invention is described about the executive example as the drawing and the explanation. And this inventior would like to clear up that this invention can be exchanged and reformed within the invention objective and mind by the other reader who has the general know-how and information.

What is claimed is:

1. A flat board type brushless DC motor, comprising:
a housing which supports a rotor through an assembly with a plurality of stators and is installed against said stators;
a stator which consists of a stator core having a ring type laminated flat structure and a plurality of teeth cores each having winding coil and are slotted at a constant distance on inner or outer circumference of a stator circle; and
a rotor which has a plurality of magnets that are installed in order to fix a circle flat rotor frame on a rotor shaft which is fixed through a bearing in said housing and to face against the teeth core on one face of rotor frame which faces said teeth core.

2. The motor as claimed in claim 1, wherein said stator further includes a laminated flat core structure of a teeth core (4) and a stator core; and said stator core has a structure configuration which is made of the multi slots with a constant distance on the inner or outer circumference of a stator core circle in order to be installed and said teeth core has a constant thickness which is consisted of a number of teeth core.

3. The motor as claimed in claim 1, wherein magnets which are installed on said rotor faces each of teeth core where said coil is wound and has even number of magnetic pole array of N and S pole according to the magnetic pole number of motor.

4. The motor as claimed in claim 1, wherein a plurality of said magnets are installed along the axial direction of the rotor to increase the rotator frame and a plurality of stators are installed in the housing in order to face against said magnets in order to increase the torque of the motor.

5. A flat board type brushless DC motor, comprising:
a housing which supports a rotor through an assembly with a plurality of stators and is installed against said stators;
a stator which consists of a stator core having a ring type laminated flat structure and a plurality of teeth cores each having winding coil and are slotted at a constant distance on inner or outer circumference of a stator circle; and
a rotor which has a induction motor that are installed in order to fix a circle flat rotor frame on a rotor shaft which is fixed through a bearing in said housing and to face against the teeth core on one face of rotor frame and is consisted of a plurality of teeth cores which are insulated by short circuit rings which faces said teeth core.

6. The motor as claimed in claim 5, wherein said stator further includes a laminated flat core structure of a teeth core (4) and a stator core; and said stator core has a structure configuration which is made of the multi slots with a constant distance on the inner or outer circumference of a stator core circle in order to be installed and said teeth core has a constant thickness which is consisted of a number of teeth core.

7. The motor as claimed in claim 5, wherein said induction motor consisted of a laminated rotor core, a teeth core which is assembled on top of rotor core and a short circuit ring that insulates between the teeth cores and exposes some part of the teeth core, and said rotor core has a structure configuration which is made of the multi slots with a constant distance on the inner or outer circumference of a stator core circle in order to be installed and said teeth core has a constant thickness which is consisted of a number of teeth core.

8. The motor as as claimed in claim 5, wherein said induction motor is installed along the axial direction of the rotor to increase the rotator frame and a plurality of stators are installed in the housing in order to face against said magnets in order to increase the torque of the motor.

9. The motor as claimed in claim 6, wherein said induction motor is installed along the axial direction of the rotor to increase the rotator frame and a plurality of stators are installed in the housing in order to face against said magnets in order to increase the torque of the motor.

10. The motor as claimed in claim 7, wherein said induction motor is installed along the axial direction of the rotor to increase the rotator frame and a plurality of stators are installed in the housing in order to face against said magnets in order to increase the torque of the motor.
